(19) United States
(12) Patent Application Publication
(10) Pub. No.: US 2026/0359271 A1
(43) Pub. Date: Nov. 12, 2026

(54) ELIMINATING DUPLICATE CALCULATIONS OF EMBEDDINGS

(71) Applicant: International Business Machines Corporation, Armonk, NY (US)

(72) Inventors: Paul Henri Muench, San Jose, CA (US); Joseph W. Dain, Tucson, AZ (US); Swaminathan Sundararaman, San Jose, CA (US)

(21) Appl. No.: 19/203,031

(22) Filed: May 8, 2025

(51) Int. Cl. G06F 16/215; G06F 16/22

(52) U.S. Cl. CPC G06F 16/215; G06F 16/2255

(57) ABSTRACT

A method, according to one approach, includes: in response to receiving a data operation at a storage system, determining whether the data operation includes new data therein by querying a global signature index. The global signature index includes hash values and embeddings for known data chunks. Moreover, in response to determining the data operation includes at least some new data therein: the new data is divided into new data chunks. Embeddings and hash values are also calculated only for the new data chunks, while existing embeddings and hash values are retained for remaining data in the data operation that is not new. The global signature index is further updated with the embeddings and hash values for the new data chunks.

### BACKGROUND

The present invention relates to data processing, and more specifically, this invention relates to processing data operations.

Increased data production has amplified the overhead associated with data management and processing. While artificial intelligence (AI) has been developed in an attempt to combat this rise in processing overhead, advancements in AI have introduced their own challenges. For instance, as the amount of data AI based models are able to ingest increases, the storage footprint associated with these models increases as well. This in turn impacts vector storage and other aspects of maintaining the data accessed and/or referenced by the AI based models. As the amount of data that is ingested increases, the costs associated with memory and compute consumed also increases.

According to an example, Retrieval Augmented Generation (RAG) is implemented in some AI based models in an attempt to increase the accuracy with which queries may be answered (e.g., solved). The basic concept involves semantically comparing large language model (LLM) queries to a base of domain knowledge, and enhancing the LLM queries with domain specific knowledge and instructions. Conventional techniques for performing semantic comparing involves combining embeddings of the LLM queries and domain knowledge. However, these conventional techniques call for the embeddings and related information to be repeatedly updated regardless of what data changes have occurred, if any.

Conventional inferencing applications are not capable of tracking data changes and therefore are simply unable to modify the process. Additionally, conventional applications are unable to address data redundancies. Accordingly, a need exists for a more efficient process of satisfying received data operations.

### SUMMARY

A method, according to one approach, includes: in response to receiving a data operation at a storage system, determining whether the data operation includes new data therein by querying a global signature index. The global signature index includes hash values and embeddings for known data chunks. Moreover, in response to determining the data operation includes at least some new data therein: the new data is divided into new data chunks. Embeddings and hash values are also calculated only for the new data chunks, while existing embeddings and hash values are retained for remaining data in the data operation that is not new. The global signature index is further updated with the embeddings and hash values for the new data chunks.

A computer program product, according to another approach, includes: one or more computer-readable storage media. The computer program product also includes program instructions that are stored on the one or more storage media to perform any combination of the foregoing methodologies.

A computer system, according to another approach, includes: a processor set, and one or more computer-readable storage media. The computer system also includes program instructions that are stored on the one or more storage media to cause the processor set to perform any combination of the foregoing methodologies.

In still another general approach, a method includes: combining data operations in response to receiving two or more data operations at a storage system in a predetermined amount of time. The method also includes determining whether the combined data operations include new data therein by querying a global signature index. In response to determining the combined data operations do include new data therein: the new data in the combined data operations is divided into a combined set of new data chunks. Embeddings and hash values are further calculated only for the new data chunks in the combined set, while existing embeddings and hash values are retained for remaining data in the combined data operations that is not new. Furthermore, the global signature index is updated with the embeddings and hash values for the new data chunks.

In yet another general approach, a computer program product includes: one or more computer-readable storage media. The computer program product also includes program instructions that are stored on the one or more storage media to perform any combination of the foregoing methodologies.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational diagram of dynamically processing data operations, in accordance with one approach.

FIG. 3A is a flowchart of a method, in accordance with one approach.

FIG. 3B is a flowchart of steps for one of the operations in the method of FIG. 3A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for eliminating duplicate calculations of embeddings for AI inferencing and training. For instance, approaches herein calculate embeddings incrementally and/or differentially for collections of data and AI based applications. Thus, only data that has been identified as being new may result in new embeddings being calculated, while data that has only been moved or copied may reuse embeddings that have already been calculated, thereby reducing compute consumption and latency, e.g., as will be described in further detail below.

In one general approach, a method includes: in response to receiving a data operation at a storage system, determining whether the data operation includes new data therein by querying a global signature index. The global signature index includes hash values and embeddings for known data chunks. Moreover, in response to determining the data operation includes at least some new data therein: the new data is divided into new data chunks. Embeddings and hash values are also calculated only for the new data chunks, while existing embeddings and hash values are retained for remaining data in the data operation that is not new. The global signature index is further updated with the embeddings and hash values for the new data chunks.

Approaches herein are thereby desirably able to eliminate duplicate calculations of embeddings for AI inferencing and training. Approaches herein achieve this at least in part by calculating embeddings incrementally and differentially for collections of data and AI based applications. Any desired embedding calculation performance may also be applied to system configurations to determine if incremental and/or differential embedding calculation may be implemented for the given configuration. Approaches herein are thereby able to determine embeddings orders of magnitude faster than any conventional products. Moreover, the fact that the improvements are in the orders of magnitude faster, allows for new domain knowledge to be continuously implemented in answers that are generated by trained AI based models (e.g., RAG models) in real-time, rather than on a weekly or even longer basis that conventional products are limited to.

In some implementations, determining whether the data operation includes new data therein includes: identifying redundant data in the data operation. The redundant data is deduplicated and further divided into new data chunks. Moreover, embeddings and hash values are calculated once for each of the deduplicated new data chunks.

Deduplicating data in a received data operation desirably reduces the amount of data that is processed in response to performing the received data operations. In other words, deduplicating any redundant data identified in the data operations further reduces the number of computations that are performed in order to satisfy the data operations. This further reduces the computational overhead associated with processing the incoming data operations as well as any associated latency.

In some implementations, it is determined that no new data exists in the received data operation. Moreover, in response to determining the data operation includes no new data therein: the method includes intentionally refraining from calculating any embeddings and/or hash values for data in the data operation. Rather, existing embeddings and hash values in the global signature index are correlated with the data in the data operation. It follows that in some implementations, retaining the existing embeddings for remaining data in the data operation that is not new thereby includes intentionally refraining from calculating any embeddings for the remaining data.

Known data chunks that have not and will not be changed as a result of the received data operations still correspond to the known data chunks that are already represented in the global signature index. Thus, by intentionally not processing this known data, approaches herein are able to significantly reduce computational overhead consumed in order to process incoming data operations. As noted above, conventional products process all data that is received regardless of whether any data changes have occurred, which has introduced significant inefficiencies. Rather, approaches herein connect known (not new) data in received data operations with information that has already been computed and stored for easy access. Intentionally refraining from making computational analysis of data that has already been ingested by the storage system thereby materially reduces overhead and conserves system resources, resulting in more efficient performance of the system as a whole.

In some implementations, the method also includes combining data operations in response to receiving two or more data operations at the storage system in a predetermined amount of time. A determination is also made as to whether the combined data operations include new data therein. In response to determining the combined data operations do include new data therein, the new data in the combined data operations is divided into a combined set of new data chunks. Moreover, embeddings and hash values are calculated only for the new data chunks in the combined set. However, in response to determining the combined data operations do not include new data therein: the method includes intentionally refraining from calculating any embeddings and/or hash values for data in the combined data operations. Rather, existing embeddings and hash values in the global signature index are correlated with the data in the combined data operations determined to not be new.

Processing data operations together in this manner improves efficiency by reducing latency and more clearly highlighting new data in comparison to known data or even duplicate copies of new data. For example, combined data operations allow for redundant data to be identified in the data operations themselves. This further reduces the computational overhead associated with processing the incoming data operations as well as any associated latency. Accordingly, embeddings, hash values, etc., are preferably only calculated for the new data chunks in the combined set. Additionally, in situations where the combined data operations do not include new data therein, approaches herein intentionally refrain from calculating any embeddings and/or hash values for the not new data that is in the combined data operations. Rather, the combined data operations are correlated with existing embeddings and hash values in the global signature index to reduce compute overhead and focus analysis on new data.

In one general approach, a computer program product includes: one or more computer-readable storage media. The computer program product also includes program instructions that are stored on the one or more storage media to perform any combination of the foregoing methodologies.

In another general approach, a computer system includes: a processor set, and one or more computer-readable storage media. The computer system also includes program instructions that are stored on the one or more storage media to cause the processor set to perform any combination of the foregoing methodologies.

In still another general approach, a method includes: combining data operations in response to receiving two or more data operations at a storage system in a predetermined amount of time. The method also includes determining whether the combined data operations include new data therein by querying a global signature index. In response to determining the combined data operations do include new data therein: the new data in the combined data operations is divided into a combined set of new data chunks. Embeddings and hash values are further calculated only for the new data chunks in the combined set, while existing embeddings and hash values are retained for remaining data in the combined data operations that is not new. Furthermore, the global signature index is updated with the embeddings and hash values for the new data chunks.

A gain, approaches herein are desirably able to eliminate duplicate calculations of embeddings for AI inferencing and training at least in part by calculating embeddings incrementally and differentially for collections of data and AI based applications. Any desired embedding calculation performance may also be applied to system configurations to determine if incremental and/or differential embedding calculation may be implemented for the given configuration. Approaches herein are thereby able to determine embeddings orders of magnitude faster than any conventional products. Moreover, the fact that the improvements are in the orders of magnitude faster, allows for new domain knowledge to be continuously implemented in answers that are generated by trained AI based models (e.g., RAG models) in real-time, which has conventionally been unachievable.

In some implementations, the method includes: intentionally refraining from calculating any embeddings and/or hash values for data in the combined data operations in response to determining the combined data operations do not include new data therein. Rather, the method includes correlating existing embeddings and hash values in the global signature index with the data in the combined data operations.

Known data chunks that have not and will not be changed as a result of the combined data operations that were received still correspond to the known data chunks that are already represented in the global signature index. Thus, by intentionally not processing this known data, approaches herein are able to significantly reduce computational overhead consumed in order to process incoming data operations. As noted above, conventional products process all data that is received regardless of whether any data changes have occurred, which has introduced significant inefficiencies. Rather, approaches herein connect known (not new) data in received data operations with information that has already been computed and stored for easy access. Intentionally refraining from making computational analysis of data that has already been ingested by the storage system thereby materially reduces overhead and conserves system resources, resulting in more efficient performance of the system as a whole. Moreover, processing multiple combined data operations together further improves efficiency.

In some implementations, determining whether the combined data operations include new data therein includes: identifying redundant data in the combined data operations. The redundant data is deduplicated and further divided into new data chunks. Moreover, embeddings and hash values are calculated once for each deduplicated new data chunk.

Deduplicating data in a received data operation desirably reduces the amount of data that is processed in response to performing the received data operations. In other words, deduplicating any redundant data identified in the data operations further reduces the number of computations that are performed in order to satisfy the data operations. This further reduces the computational overhead associated with processing the incoming data operations as well as any associated latency. Moreover, processing multiple combined data operations together further improves efficiency.

In some implementations, it is determined that no new data exists in the combined data operations. Moreover, in response to determining the combined data operations include no new data therein: the method includes intentionally refraining from calculating any embeddings and/or hash values for data in the combined data operations. Rather, existing embeddings and hash values in the global signature index are correlated with the data in the combined data operations. It follows that in some implementations, retaining the existing embeddings for remaining data in the combined data operations that is not new thereby includes intentionally refraining from calculating any embeddings for the remaining data.

Known data chunks that have not and will not be changed as a result of the combined data operations still correspond to the known data chunks that are already represented in the global signature index. Thus, by intentionally not processing this known data, approaches herein are able to significantly reduce computational overhead consumed in order to process incoming data operations. Intentionally refraining from making computational analysis of data that has already been ingested by the storage system thereby materially reduces overhead and conserves system resources, resulting in more efficient performance of the system as a whole. Moreover, processing multiple combined data operations together further improves efficiency.

In yet another general approach, a computer program product includes: one or more computer-readable storage media. The computer program product also includes program instructions that are stored on the one or more storage media to perform any combination of the foregoing methodologies.

In other implementations, users and/or running applications generate data operations (e.g., data requests) that are submitted to a central data storage system for evaluation and performance. The data operations that are submitted to the storage system vary in type (e.g., data read operations, data write operations, data relocation operations, etc.) and number depending on the situation. For example, periods of high intensity may involve relatively larger workloads that involve a greater number of data operations being submitted to storage for performance. In response to receiving more than one data operation at the storage system, the data operations are combined (e.g., merged) and evaluated in parallel. Specifically, the combined data operations are inspected for any new data that is included therein. In response to identifying new data (data that has not previously been ingested by the storage system), the new data is separated from any remaining known (not new) data and divided into a desired number of new data chunks. Embeddings and hash values may thereby be calculated only for the new data chunks, while existing embeddings and hash values already in a global storage index are retained for any remaining data in the data operation that is identified as not being new data. Moreover, the global signature index is updated with the embeddings and hash values for the new data chunks only. Intentionally not processing known data allows for approaches herein to significantly reduce computational overhead consumed by a system while processing incoming data operations. This is achieved at least in part by approaches herein connecting known (not new) data in received data operations with information that has already been computed and stored for future access. Intentionally refraining from making computational analysis of data that has already been ingested by the storage system thereby materially reduces overhead and conserves system resources, resulting in more efficient performance of the system as a whole.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that is at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved data operation code in block 150 for eliminating duplicate calculations of embeddings for AI inferencing and training. For instance, approaches herein calculate embeddings incrementally and/or differentially for collections of data and AI based applications. Thus, only data that has been identified as being new may result in new embeddings being calculated, while data that has only been moved or copied may reuse embeddings that have already been calculated, thereby reducing compute consumption and latency, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

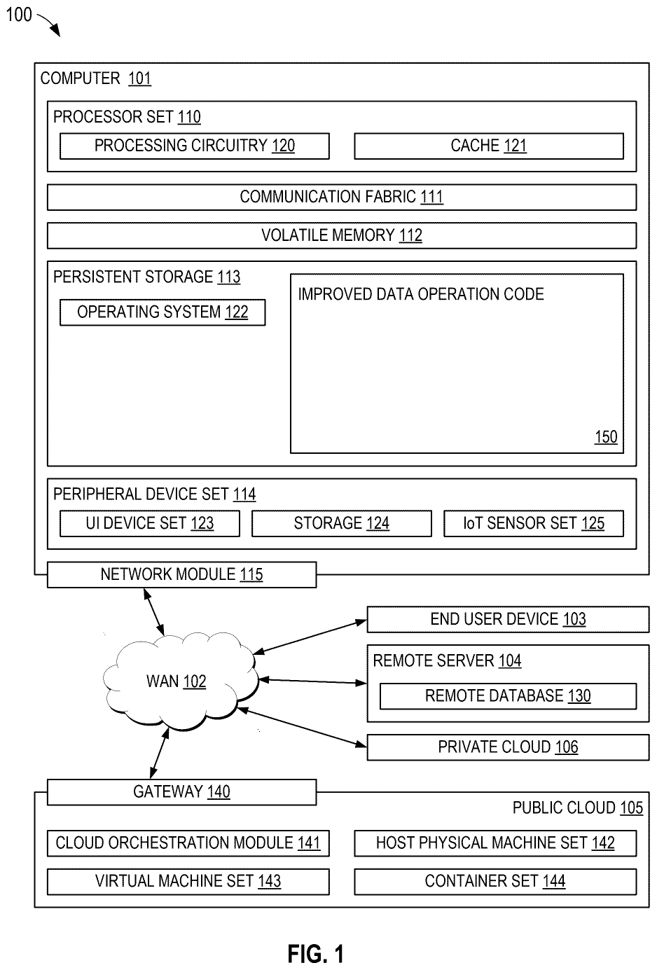

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LA Ns typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By “integrated with,” what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, increased data production has amplified the overhead associated with data management and processing. While AI has been developed in an attempt to combat this rise in processing overhead, advancements in AI have introduced their own set of issues. For instance, conventional products have experienced impedance issues with respect to the amount of data AI based models are able to ingest compared to the associated storage demand. These conventional products have thereby been unable to operate and maintain data global signature indexes in a cost-effective manner. As the amount of data that is ingested increases, the costs associated with memory and compute consumption significantly increase.

For example, RAG is implemented in some AI based models in an attempt to increase the accuracy with which queries may be answered (e.g., solved). The basic concept involves semantically comparing LLM queries to a base of domain knowledge, and enhancing the LLM queries with domain specific knowledge and instructions. Conventional techniques for performing semantic comparing involves combining embeddings of the LLM queries and domain knowledge. However, these conventional techniques call for the embeddings and related information to be repeatedly updated regardless of what data changes have occurred, if any, which has introduced significant inefficiencies. For instance, calculating embeddings in this manner is resource intensive both in time and GPU throughput.

Conventional inferencing applications are not capable of tracking data changes and therefore are simply unable to address these significant inefficiencies. Additionally, conventional applications are unable to address data redundancies, e.g., as high as 90% depending upon the data and type of storage used. These redundancies occur both at the storage object granularity (e.g. shared files) and the storage sub-object granularity (e.g. shared data in separate files). However, the conventional products are simply incapable of addressing this shortcoming. Accordingly, this problem generalizes to any inferencing or training process that operates on a dynamic collection of data and applications that involve embeddings. This problem is also becoming worse over time as the amount of data being stored and managed can be in the petabytes or even higher, translating to weeks of time and GPU resources that are unnecessarily consumed.

In sharp contrast to the foregoing shortcomings experienced by conventional systems, approaches herein are desirably able to eliminate duplicate calculations of embeddings for AI inferencing and training. Approaches herein achieve this at least in part by calculating embeddings incrementally and differentially for collections of data and AI based applications. Approaches are able to incrementally calculate embeddings by detecting any changes (e.g. the addition, delete, movement, copy, modification, etc. of data) that occur in storage, and calculating embeddings only for new data (e.g., data that has never been seen in a data system). For instance, only data that has been identified as being modified may call for new embeddings to be calculated, while data that has only been moved or copied may reuse embeddings that have already been calculated, thereby reducing compute consumption and latency.

Furthermore, approaches herein are able to differentially calculate embeddings by using storage knowledge of data sharing to only calculating embeddings once for each portion of data (e.g., data chunk). According to a non-limiting example, two AI applications may share the same data either directly or through links. Identifying this shared data allows for approaches herein to selectively calculate embeddings only once, rather than multiple times to only produce the same results. If an AI application implements a flexible embedding model, storage may automatically share embedding models between AI applications. Storage systems may also have knowledge of data deduplication. Accordingly, when data is duplicated, only one embedding is calculated for all users of that duplicate data. The embedding calculations may further be used across storage systems by sharing the signature (hash of the data chunks) along with the calculated embedding. This additional information may result in a marginal reduction in storage capacity, but can significantly reduce the redundant embedding calculations that are performed, thereby significantly improving performance of the system as a whole.

Approaches herein are also able to reduce compute consumption and latency by searching for data changes that are concentrated in time and occur in a predetermined amount of time. For instance, data changes may happen faster than an AI application is able to process them. Thus, to avoid thrashing compute usage, time series analysis may be used to predict when data changes have ceased (at least temporarily). In response to determining that the data changes have actually ceased, new embedding(s) may be calculated, thereby avoiding unnecessary consumption of system resources. Coalescing of embedding calculations can also enable applications to eliminate any supplemental copies of data that are maintained only to calculate embeddings, e.g., as will be described in further detail below.

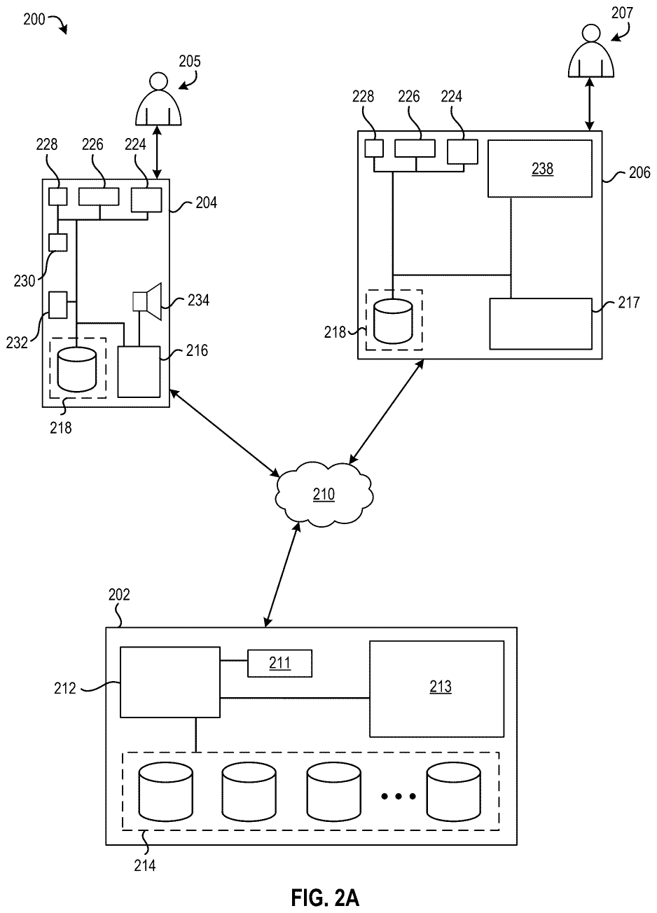

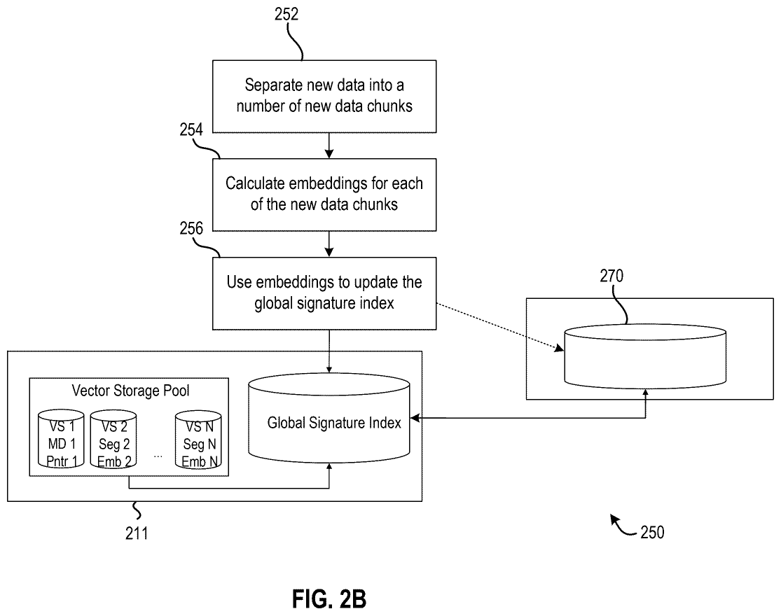

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting. For instance, while users and administrators may be described as being individuals in various implementations herein, a user and/or an administrator may be an application, an organization, a preset process, one or more AI based applications and/or models automatically running in the system, etc. The use of “data,” “data chunks,” “metadata,” and “information” herein are in no way intended to be limiting either, and may include any desired type of details, e.g., depending on the type of operating system implemented on the user device 204, edge node 206, and/or central server 202. For instance, depending on the approach a data chunk as used herein may include text, stationary image based information (e.g., pixel outputs), motion based image information (e.g., video clips), etc. Data chunks as used herein may thereby be of any desired size. Moreover, data chunks in a given system may be of different sizes or the same size as each other depending on the approach. “Data” as used herein may also include files and/or objects that are of any desired size and which may be located in one or more data storage systems depending on the approach, e.g., as would be appreciated by one skilled in the art after reading the present description.

With continued reference to FIG. 2A, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 and/or processor 212 are able to train one or more AI based models. For instance, AI model(s) may be trained in some approaches to inspect and determine whether data operations include new data therein. Moreover, in response to identifying the new data, AI based models herein are able to divide the new data into new data chunks, and calculate embeddings and hash values only for these newly formed data chunks while retaining existing embeddings and hash values for remaining data in the data operation that is not new. In other words, the AI based models are able to identify known data chunks that are not changed in received data operations and therefore correspond to the known information already stored in a global signature index. These AI based models are thereby able to eliminate duplicate calculations of embeddings for AI inferencing and training, thereby significantly reducing computational overhead consumed by processing incoming data operations.

As noted above, conventional products process all data that is received regardless of whether data changes have actually occurred, which has introduced significant inefficiencies. For instance, calculating embeddings in this conventional manner is resource intensive both in time and GPU throughput. However, conventional inferencing applications are simply incapable of tracking data changes or data deduplications, and are therefore fundamentally unable to address these significant run-time inefficiencies. Accordingly, this conventional problem generalizes to any inferencing or training process that operates on a dynamic collection of data and applications that involve embeddings. This problem is also becoming worse over time as the amount of data being stored and managed can be in the petabytes or even higher, translating to weeks of time and GPU resources that are unnecessarily consumed.

Approaches herein are again able to overcome these significant conventional shortcomings by enabling systems to identify new data therein (e.g., in response to received data operations) and focus system resources on processing only the new data. Meanwhile, data that is not new to the system (e.g., data known by the system) is intentionally not processed, but rather simply correlated with known embeddings, hash values, metadata, etc., that already exist in a global signature index.

For example, portions of a dataset that has been generated at, received at, stored at, identified at, etc. the edge node 206 may be sent to the central server 202. According to an example, the central server 202 may manage a global signature index having vectors and pointers correlated with the different data chunks that are received and stored therein. Data chunks already stored and represented in the global signature index (also referred to herein as a “vector database”) that are determined as matching incoming data chunks may thereby be used to avoid performing duplicate calculations of embeddings for AI inferencing and training, e.g., as will be described in further detail below.

In some approaches, AI module 213 may implement prompt tuning to achieve this functionality, more specifically multi-prompt tuning (MPT). With respect to the present description, “prompt tuning” refers to the process of adapting a base pretrained model to each desired task via conditioning on learned prompt vectors. For instance, prompt tuning may be used to efficiently adapt LLM s to multiple downstream tasks. It should also be noted that “MPT” refers to a process, which initially includes learning a single transferable prompt by distilling knowledge from multiple task-specific source prompts. Furthermore, multiplicative low rank updates to this shared prompt are learned to efficiently adapt it to each downstream target task, e.g., as would be appreciated by one skilled in the art after reading the present description. As a result, approaches herein are able to exploit the rich cross-task knowledge with prompt vectors in a multitask learning setting.

Accordingly, the AI module 213 and/or data storage array 214 preferably include a global signature index that has a number of data chunks which have each been applied to any desired number of encoding models. In some approaches, each of multiple encoding models may correspond to a different AI based implementation that is supported by the system. In other words, each encoding model may apply a different interpretation to a given data chunk in a way that is unique to the respective AI based implementation. In one example, language based RAG applications may correspond to each of the respective encoding models. In another example, each encoding model may correspond to a different LLM. The LLMs that may be supported by the system may include, but are in no way limited to, the T5 transformer model, the Bidirectional Encoder Representations from Transformers (BERT) language model, the ELECTRA language model, etc., or any other LLMs (e.g., language spaces) that would be apparent to one skilled in the art after reading the present description. It follows that each of the encoding models may be configured (e.g., based at least in part on the corresponding AI based implementation) to evaluate a particular language (e.g., human language, computer coding language, motion based communication, etc.), and/or a particular medium (e.g., text, images, videos, etc.), and/or a particular type of data (e.g., sensor data, answers generated by other AI based models, user data, application data, etc.) depending on the desired approach.

Each entry in the global signature index may be compared against vector information received from other locations. For example, a mean vector received from the edge node 206 may be compared against the entries in the global signature index and identify whether any matching entries exist in the global signature index. In some approaches, entries in the global signature index may be organized such that the distance between entries is inversely proportional to how similar the entries are, e.g., in order to reduce latency associated with identifying whether any known data chunks in the global signature index match incoming data chunks.

With continued reference to FIG. 2A, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include any desired number and/or type of AI-based models. It follows that AI module 238 may implement similar, the same, or different characteristics as AI module 213 in central server 202.

Referring momentarily now to FIG. 2B, a representational diagram 250 of dynamically processing data operations having data chunks that have been ingested to maintain a global signature index, is illustrated in accordance with one approach which is in no way intended to be limiting. As an option, the present diagram 250 may be implemented in conjunction with features from any other approach listed herein, such as those described with reference to the other FIGS., such as FIG. 2A. However, such diagram 250 and others presented herein may be used in various applications and/or in permutations which may or may not be specifically described in the illustrative approaches listed herein. Further, the diagram 250 presented herein may be used in any desired environment. Thus FIG. 2B (and the other FIGS.) may be deemed to include any possible permutation.

As noted above, the process of developing and maintaining the global signature index involves ingesting data operations, and determining whether any new data is included therein. Any identified new data is thereby separated into a number of new data chunks, and embeddings are calculated for each of the new data chunks. See operations 252, 254 respectively. Depending on the approach, the base data and/or identified new data itself may be in different forms. For instance, the base data may include text files, images, videos, audio files, performance metrics, outputs produced by one or more trained AI based models, etc. Moreover, depending on the type of information that is included in the base data, new information identified therein may be divided into the different data chunks differently. In one example, operation 252 includes shredding new data identified in a portable document format (PDF) file into any desired number of new data chunks, each new data chunk including an about same amount of new data therein. In another example, operation 252 includes partitioning the various pixels in a new image file (e.g., not previously received at the system) into any desired number of new data chunks, each respective new data chunk including about a same number of pixels therein.

The calculated embeddings (and corresponding hash values) are thereby used to update the Global Signature Index. See operation 256. The data chunks are also preferably used to update the data storage. It follows that operation 256 may include causing the new data chunks to be stored in the data storage 270 and/or modifying the Global Signature Index to reflect the embeddings, hash values, metadata, etc. computed for the new data chunks. In preferred approaches, the new data chunks are used to calculate embeddings and thereby form respective vectors and metadata that is associated therewith. For instance, the identified new data chunks may be vectorized using any processes that would be apparent to one skilled in the art after reading the present description. In some approaches, which are in no way intended to be limiting, pointers may also be created for each of the new data chunks that identify the logical and/or physical location in data storage 270 that the respective new data chunks are stored. It follows that in some approaches, the data chunks themselves may be stored externally to the Global Signature Index, thereby conserving capacity for a larger number of vectorized entries and allowing the system to manage a larger amount of data than conventionally achievable. This also overcomes the cost based restrictions that have plagued conventional products, e.g., as will be described in further detail below.

Looking to the Global Signature Index, the present approach includes a Vector Storage Pool therein that arranges the entries based on the corresponding new data chunk. For instance, N new data chunks formed in operation 252 may further be converted into N segmentation embeddings. The N segmentation embeddings may thereby be used to form (e.g., create) N Vector Storage Pools, each of which may include a unique vector storage identifier (e.g., VS1, VS2, . . . , VSN), metadata (e.g., MD1, MD2, . . . , MDN) from the new data chunks that were received, and at least one pointer (e.g., Pntr 1, Pntr 2, . . . , Pntr N) that correspond to the respective data chunk in storage (e.g., the data storage 270). These vector storage pools thereby provide an efficient and segmented process of locating relevant sections of known data chunks to determine whether incoming data operations include any new data therein or only known data therein.

In preferred approaches, the global signature index is formed by identifying mappings between received queries and vector storage and/or segment relevance, e.g., as described herein. Moreover, one or more AI based models may be trained on the information included in the global signature index, and may thereby be configured identify a relevant portion of the information included in the Vector Database. A gain, this relevant portion of the information may thereby be used to determine whether data operations include new data therein.

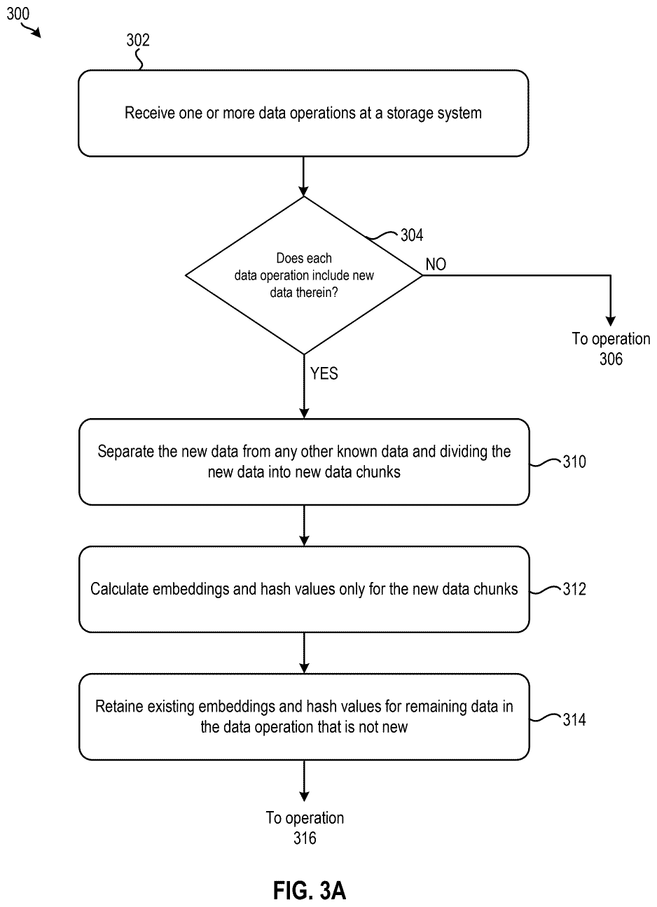

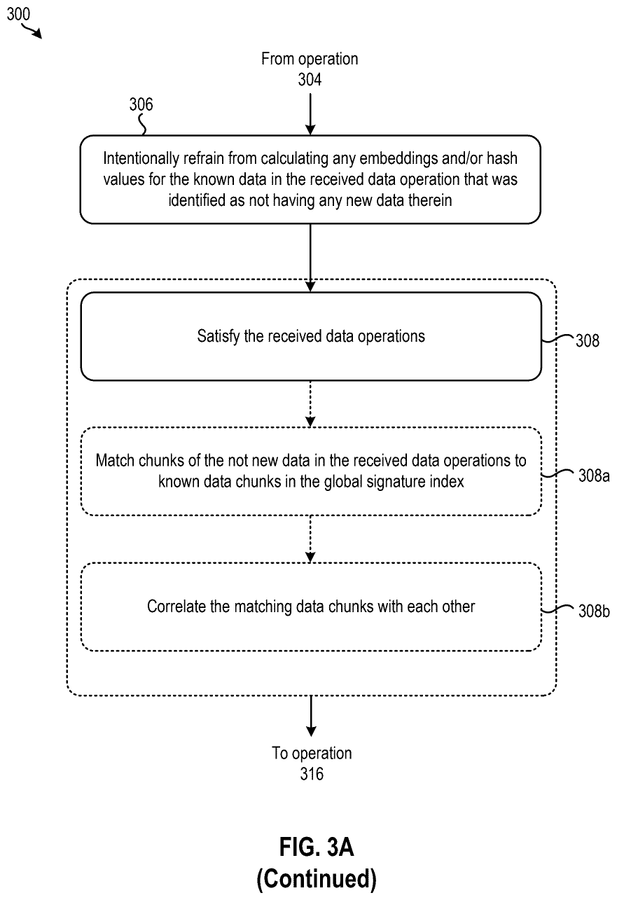

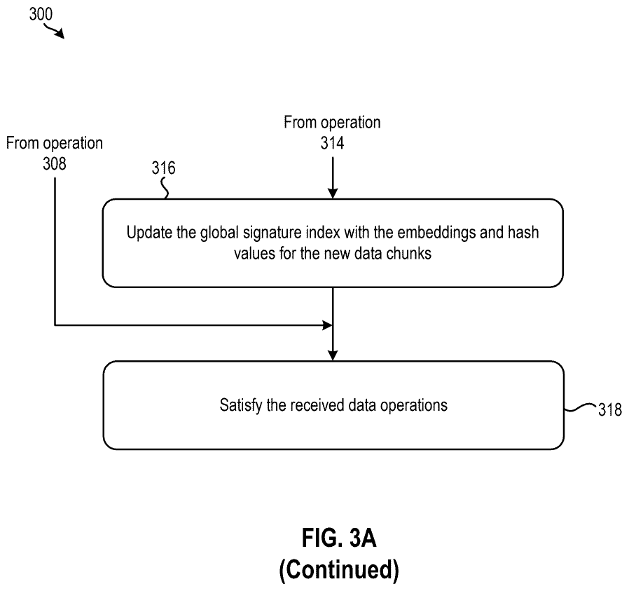

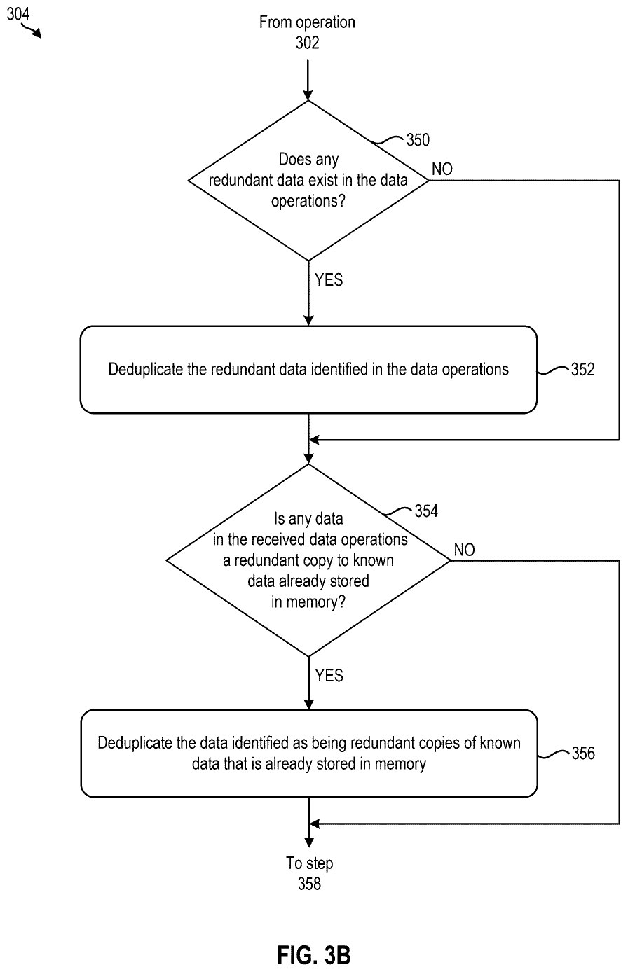

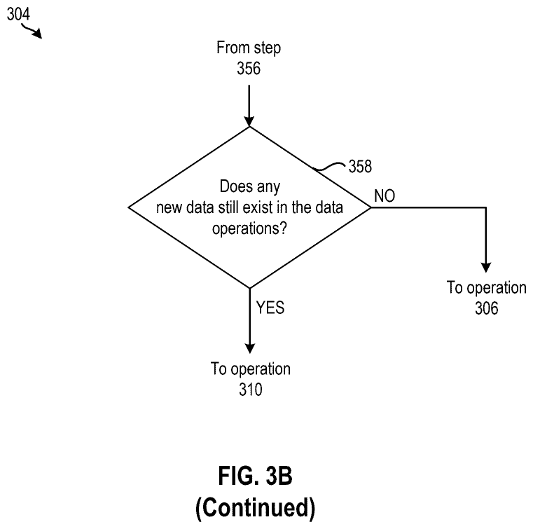

Looking now to FIG. 3A, a method 300 for eliminating duplicate calculations of embeddings for AI inferencing and training is illustrated in accordance with one approach. Specifically, method 300 involves calculating embeddings incrementally and/or differentially for collections of data and AI based applications. For instance, only data that has been identified as being new may result in new embeddings being calculated, while data that has only been moved or copied may reuse embeddings that have already been calculated, thereby reducing compute consumption and latency, e.g., as will be described in further detail below.

The method 300 may be performed in accordance with the present invention in any of the environments depicted in FIGS. 1-2B, among others, in various approaches. Of course, more or less operations than those specifically described in FIG. 3 may be included in method 300, as would be understood by one of skill in the art upon reading the present descriptions.

Each of the steps of the method 300 may be performed by any suitable component of the operating environment. For example, any one or more of the operations in method 300 may be performed by a controller and/or AI module at a central location (e.g., see processor 212 and/or AI module 213 of FIG. 2A). In other approaches, the method 300 may be partially or entirely performed by a controller, a processor, a computer, etc., or some other device having one or more processors therein. Thus, in some approaches, method 300 may be a computer-implemented method. Moreover, the terms computer, processor and controller may be used interchangeably with regards to any of the approaches herein, such components being considered equivalents in the many various permutations of the present invention.

For those approaches having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 of method 300 includes receiving one or more data operations at a storage system. The number of data operations that are received varies depending on factors, e.g., such as network traffic, running applications, real-time performance, user preferences, etc. The data operation(s) may be received from a number of different sources depending on the approach. For instance, data operations may be received from one or more of a user, a remote system, running applications, trained AI based models, etc. Additionally, the type(s) of data operation(s) that are received may vary depending on the approach. For instance, some of the received data operations may actually introduce new data to the storage system, while other received data operations may only involve known data that already exists in the storage system. In one example, a data write operation having new data intended to be stored in the storage system may be received at operation 302, inspected, and processed, e.g., as described in further detail below. In another example, a data read operation requesting known data already in the storage system and having no new data therein may be received at operation 302, inspected, and processed. In still another example, a data relocate operation having no new data therein may be received along with a data write operation having new data and know data therein.

In response to receiving two or more data operations at the storage system in a predetermined amount of time, the data operations are preferably combined and evaluated together. For instance, the combined data operations are evaluated, and a determination is made as to whether the combined data operations include new data therein. Processing data operations together in this manner improves efficiency by reducing latency and more clearly highlighting new data in comparison to known data or even duplicate copies of new data. In response to determining the combined data operations include new data therein, the new data is extracted and divided into a combined set of new data chunks. Accordingly, embeddings, hash values, etc., are preferably only calculated for the new data chunks in the combined set. However, in response to determining combined data operations do not include new data therein, approaches herein intentionally refrain from calculating any embeddings and/or hash values for the not new data that is in the combined data operations. Rather, the combined data operations are correlated with existing embeddings and hash values in the global signature index, e.g., as will be described in further detail below.

It follows that each of the data operations that are received are preferably inspected to determine whether new data is being introduced to the storage system. Accordingly, method 300 advances from operation 302 to operation 304 in response to receiving one or more data operations at the storage system. There, operation 304 includes determining whether each of the received data operations includes new data therein. In preferred approaches, new data may be identified in operation 304 by inspecting each of the received data operations and using information gleaned therefrom to query a global signature index of the storage system. The global signature index includes hash values and embeddings for each of the known data chunks that already exist in the storage system. In other words, the global signature index is maintained across storage systems and organizes information (e.g., embeddings, hash values, etc.) which represents the data chunks in storage for more efficient access. The global signature index is thereby able to assist in identifying new data in received data operations on the fly without causing any data errors (e.g., data loss). The global signature index even desirably includes share chunk signatures and their respective embeddings in preferred approaches.

Referring momentarily to FIG. 3B, exemplary steps of determining whether one or more data operation(s) include new data therein are illustrated in accordance with one approach. It follows that one or more of these steps may be used to perform operation 304 of FIG. 3A. However, it should be noted that the sub-operations of FIG. 3B are illustrated in accordance with one approach which is in no way intended to be limiting.

As shown, step 350 includes determining whether any redundant data exists in the data operation(s). In other words, step 350 includes comparing all of the data that is included in the received data operation(s) and determining whether any portions of the data is the same. Copies of the same data identified in the received data operation(s) are redundant and preferably removed before being incorporated into the global signature index and/or storage. Accordingly, the flowchart advances to step 352 in response to determining that redundant data does exist in the data operations. There, step 352 includes deduplicating the redundant data identified in the data operations. It follows that in situations where redundant data is not identified in the received data operations themselves, step 352 may be skipped. The flowchart is thereby shown as advancing directly to step 354 from step 350 in response to determining that no redundant data exists in the data operation(s).

There, step 354 further includes determining whether any of the data in the received data operation(s) is a redundant copy to known data already stored in memory. In response to identifying at least some data in the data operation(s) that is a copy of known data already stored in memory, the flowchart advances from step 354 to step 356 where the redundant data is deduplicated. In other words, step 356 includes deduplicating the data identified as being redundant copies of known data that is already stored in memory (e.g., in response to performing previous data operations). The deduplicated data may thereby be stored without consuming more storage capacity than otherwise needed.

The flowchart advances from step 356 to step 358. Similarly, the flowchart jumps from step 354 directly to step 358 in response to determining that none of the data in the data operation(s) is a copy of known data already stored in memory. There, step 358 includes determining whether any new data still exists in the data operations. In other words, step 358 determines whether any new data still exist in the data operations after performing the deduplication in steps 352 and/or 356. In response to determining the data operations still include data that has not yet been deduplicated, the flowchart is shown as advancing to operation 310. However, in response to determining the data operations do not include any data (i.e., all data therein has been deduplicated), the flowchart is shown as advancing to operation 306, e.g., as will be described in further detail below.

Returning now to FIG. 3A, method 300 advances from operation 304 to operation 306 in response to determining that the received data operation does not include any new data therein. There, operation 306 includes intentionally refraining from calculating any embeddings and/or hash values for the known data in the received data operation that was identified as not having any new data therein. In some approaches, operation 306 may involve sending one or more instructions to the global signature index and/or a controller therein, the one or more instructions preventing the global signature index and/or a controller therein from performing any computations that are associated with introducing new data to the storage system. For example, the one or more instructions may cause the global signature index and/or a controller therein to enter a “resource conservation mode” that prevents any new embeddings, hash values, metadata, etc., from being determined and/or added to the storage system.

Rather, data operations that have known (or not new) data and/or do not involve adding new data to the storage system are correlated with existing entries in the storage system. Method 300 thereby advances from operation 306 to operation 308 where existing embeddings and hash values in the global signature index are correlated with the (known) data in the data operation. In other words, operation 308 includes connecting known (not new) data in received data operations with information that has already been computed and stored for easy access. Intentionally refraining from making computational analysis of data that has already been ingested by the storage system thereby materially reduces overhead and conserves system resources, resulting in more efficient performance of the system as a whole.

According to some approaches, the process of correlating existing embeddings and hash values in the global signature index with known data in received data operations involves identifying matching data chunks. Operation 308 is thereby shown as including step 308a which includes matching chunks (e.g., portions) of the not new data in the received data operations to known data chunks in the global signature index. For instance, step 308a may include dividing the known data in the received data operations into a number of data chunks that do not include new data therein, and comparing the data chunks formed from the received data operations with known data chunks that are already in the storage system. In response to identifying a known data chunk in the storage system that matches one of the data chunks formed from the received data operations, the data chunks are correlated with each other. See step 308b. According to some approaches, two or more data chunks may be correlated with each other using one or more pointers, flags, logical links, physical connections, etc. This again allows for approaches herein to desirably avoid consuming compute overhead to process data that has already been incorporated into a storage system. This desirably overcomes the shortcomings with compute throughput that have been experienced by conventional products.

From operation 308, method 300 of FIG. 3A jumps directly to operation 318. There, operation 318 includes performing the data operations. In other words, operation 318 includes satisfying the data operations originally received in operation 302. The type of data operation(s) originally received impacts how each may be satisfied in operation 318, e.g., as will be described in further detail below. For example, a data delete operation may be satisfied by removing the referenced data from memory and returning a confirmation to a source of the received data delete operation. In another example, a data relocate operation may be satisfied by moving known data chunks to target locations in memory.

Returning now to operation 304, method 300 proceeds to operation 310 in response to determining that at least one received data operation does include new data therein. In other words, method 300 advances from operation 304 to operation 310 in response to identifying data in the data operations that has not previously been received (e.g., processed and stored) at the storage system. There, operation 310 includes separating the new data from any other known data and dividing the new data into new data chunks. In other words, operation 310 includes isolating any data identified as being completely new to the storage system, and dividing the identified new data into a desired number of chunks or portions. The process of dividing the new data into data chunks may vary depending on the approach. For instance, data chunks may be of any desired size, have any desired formatting, include any desired type of information, etc. For instance, depending on the approach, a data chunk as used herein may include text, stationary image based information (e.g., pixel groupings), motion based image information (e.g., video clips), etc. Moreover, the data chunks that are in a given system may be of different sizes compared to each other in some approaches, while in other approaches, the data chunks in a storage system may be about the same size as each other. Each of the data chunks themselves may also include a portion of files, objects, raw data, etc., or any desired type of information, e.g., as would be appreciated by one skilled in the art after reading the present description.

In some approaches, operation 310 involves sending one or more instructions to the global signature index and/or a controller therein, the one or more instructions causing the global signature index and/or a controller therein to perform any desired determinations that are associated with introducing the identified new data to the storage system. For example, the one or more instructions may cause the global signature index and/or a controller therein to inspect the new data and determine a number of chunks, a size of each chunk, a storage location for each chunk, etc., that is formed in operation 310. In one example, operation 310 includes shredding new data identified in a portable document format (PDF) file into any desired number of new data chunks, each new data chunk including an about same amount of new data therein. In another example, operation 310 includes partitioning the various pixels in a new image file (e.g., not previously received at the system) into any desired number of new data chunks, each respective new data chunk including about a same number of pixels therein.

From operation 310, method 300 advances to operation 312. There, operation 312 includes calculating embeddings and hash values only for the new data chunks. In other words, identifying details are selectively determined for the new data chunks formed in operation 310. Intentionally choosing to only consume compute overhead to form identifying details for data that has not yet been introduced to a storage system improves performance of the system overall. As noted above, intentionally refraining from making computational analysis of data that has already been ingested by the storage system desirably reduces overhead and conserves system resources, resulting in more efficient performance of the system as a whole. Moreover, the embeddings may be calculated using any processes and/or procedures that would be apparent to one skilled in the art after reading the present description.

From operation 312, method 300 advances to operation 314. There, operation 314 includes retaining existing embeddings and hash values for remaining data in the data operation that is not new. In other words, operation 314 includes intentionally refraining from calculating any embeddings for the remaining data in the data operation. More specifically, operation 314 includes intentionally refraining from consuming any system resources (e.g., compute throughput) to process data in the data operations received at operation 302 that is not new data. Known data chunks that have not been changed as a result of the received data operations therefore still correspond to the known data chunks that are already represented in the global signature index. Again, by intentionally not processing this known data, approaches herein are able to significantly reduce computational overhead consumed as a result of processing incoming data operations. As noted above, conventional products process all data that is received regardless of whether any data changes have occurred, which has introduced significant inefficiencies.

With continued reference to FIG. 3A, method 300 advances from operation 314 to operation 316. There, operation 316 includes updating the global signature index with the embeddings and hash values for the new data chunks. In other words, operation 316 involves modifying the repository to reflect the new data chunks that were formed in response to receiving the data operations and identifying the new data therein. While the global signature index is described in the current approach as being updated each iteration of method 300 that advances to operation 310, changes may be made to the index with different frequency depending on the approach. For instance, some approaches may update the global signature index periodically at a predetermined interval (e.g., specific time(s) of the day) in order to remove any unexpected spikes in compute consumption that may otherwise occur in response to an influx of data operations with new data therein being received at the storage system. In other approaches, the global signature index may be updated in response to a predetermined number of outstanding modifications accumulating in a queue, receiving a command from a user, network traffic lowering below a predetermined threshold, the storage system entering a low power and/or low demand mode, etc. In still other approaches, the global signature index may be updated in response to each data operation received and identified as having new data therein, as well as supplementally updated in response to any of the foregoing conditions being met. In some approaches, the update rate for the global signature index may be impacted based on outstanding data operations, current latency, availability of AI based models, etc.

From operation 316, method 300 advances to operation 318 where the data operations are performed. In other words, operation 318 includes satisfying the data operations originally received in operation 302. The type of data operation(s) originally received impacts how each may be satisfied in operation 318. For example, a data read operation may be satisfied by copying the requested data from memory and returning it to a source of the received data read operation. In another example, a data write operation may be satisfied by writing new data chunks into memory and/or referencing (e.g., pointing to) known data chunks in memory.

It should also be noted that in some approaches, the data chunks may be selectively arranged in the global signature index such that similar data chunks are logically and/or physically positioned adjacent to each other in storage. In some approaches, the “similar” data chunks may include information that has been identified as typically being accessed together (e.g., originating from a same file). In other approaches, “similar” data chunks are formed from text segmentations having similar meaning and therefore may include similar lexical scores. Arranging the data chunks in this manner allows for similar (or at least related) data to be co-located in storage and retrieved together in response to receiving similar requests. Again, by intentionally co-locating data chunks that are identified as being “similar,” approaches herein are desirably able to further reduce latency by reducing data access times, e.g., as would be appreciated by one skilled in the art after reading the present description. Accordingly, updating the global signature index may reflect any rearrangements that are made to the data chunks in storage such that any new data chunks are positioned adjacent to most similar ones of the known data chunks already in storage.

Method 300 may end in response to satisfying the data operation(s) in operation 318. However, it should be noted that although method 300 may end in response to performing operation 308, any one or more of the operations included in method 300 may be repeated in order to process additional data operations that are received. In other words, any one or more of the operations included in method 300 may be repeated for any number of data operations that are received at a storage system over time. It follows that method 300 may return to operation 302 and wait (e.g., in an idol or low-power setting) for subsequent data operations to be received.

A gain, approaches herein are able to significantly reduce the amount of time and compute (e.g., GPU) resources that are consumed as a result of implementing incremental and differential calculations of embeddings. Any desired embedding calculation performance may also be applied to system configurations to determine if incremental and/or differential embedding calculation may be implemented for the given configuration. This further improves the applicability of the improvements that are achieved by the approaches herein. Approaches herein are thereby able to determine embeddings orders of magnitude faster than any conventional products. Moreover, the fact that the improvements are in the orders of magnitude faster, allows for new domain knowledge to be continuously implemented in answers that are generated by trained AI based models (e.g., RAG models) in real-time, rather than on a weekly or even longer basis that conventional products are limited to.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

1. A method comprising:
in response to receiving a data operation at a storage system, determining that the data operation includes new data therein by querying a global signature index, wherein the global signature index includes hash values and embeddings for known data chunks; and
in response to determining the data operation includes at least some new data therein:
dividing the new data into new data chunks;
calculating the embeddings and the hash values only for the new data chunks;
retaining existing embeddings and hash values for remaining data in the data operation that is not new; and
updating the global signature index with the embeddings and the hash values for the new data chunks.

2. The method of claim 1, further comprising:
in response to receiving two or more data operations at the storage system in a predetermined amount of time, combining the data operations;
determining that the combined data operations include new data therein; and
in response to determining the combined data operations include new data therein:
dividing the new data in the combined data operations into a combined set of new data chunks, and
calculating the embeddings and the hash values only for the new data chunks in the combined set.

3. The method of claim 2, further comprising:
in response to determining the combined data operations do not include new data therein:
intentionally refraining from calculating any of the embeddings and the hash values for data in the combined data operations; and
correlating the existing embeddings and the hash values in the global signature index with the data in the combined data operations.

4. The method of claim 1, wherein the determining that the data operation includes new data therein includes:
identifying redundant data in the data operation;
deduplicating the redundant data;
dividing the deduplicated data into the new data chunks; and
calculating embeddings and hash values once for each deduplicated new data chunk.

5. The method of claim 1, wherein the retaining the existing embeddings for remaining data in the data operation that is not new includes intentionally refraining from calculating any of the embeddings for the remaining data.

6. The method of claim 1, further comprising:
in response to determining the data operation includes no new data therein:
intentionally refraining from calculating any of the embeddings and/or the hash values for data in the data operation; and
correlating the existing embeddings and the hash values in the global signature index with the data in the data operation.

7. A computer program product comprising:
one or more computer-readable storage media; and
program instructions stored on the one or more storage media to perform operations comprising:
in response to receiving a data operation at a storage system, determining that the data operation includes new data therein by querying a global signature index, wherein the global signature index includes hash values and embeddings for known data chunks; and
in response to determining the data operation includes at least some new data therein:
dividing the new data into new data chunks;
calculating the embeddings and the hash values only for the new data chunks;
retaining existing embeddings and hash values for remaining data in the data operation that is not new; and
updating the global signature index with the embeddings and the hash values for the new data chunks.

8. The computer program product of claim 7, wherein the operations further comprise:
in response to receiving two or more data operations at the storage system in a predetermined amount of time, combining the data operations;
determining that the combined data operations include the new data therein; and
in response to determining the combined data operations include the new data therein:
dividing the new data in the combined data operations into a combined set of the new data chunks, and
calculating embeddings and hash values only for the new data chunks in the combined set.

9. The computer program product of claim 8, wherein the operations further comprise:
in response to determining the combined data operations do not include the new data therein:
intentionally refraining from calculating any of the embeddings and/or the hash values for data in the combined data operations; and
correlating the existing embeddings and hash values in the global signature index with the data in the combined data operations.

10. The computer program product of claim 7, wherein the determining that the data operation includes new data therein includes:
identifying redundant data in the data operation;
deduplicating the redundant data;
dividing the deduplicated data into the new data chunks; and
calculating the embeddings and the hash values once for each deduplicated new data chunk.

11. The computer program product of claim 7, wherein the retaining the existing embeddings for remaining data in the data operation that is not new includes intentionally refraining from calculating any of the embeddings for the remaining data.

12. The computer program product of claim 7, wherein the operations further comprise:
in response to determining the data operation includes no new data therein:
intentionally refraining from calculating any of the embeddings and the hash values for data in the data operation; and
correlating the existing embeddings and hash values in the global signature index with the data in the data operation.

13. A computer system comprising:
a processor set;
one or more computer-readable storage media; and
program instructions stored on the one or more storage media to cause the processor set to perform operations comprising:
in response to receiving a data operation at a storage system, determining that the data operation includes new data therein by querying a global signature index, wherein the global signature index includes hash values and embeddings for known data chunks; and
in response to determining the data operation includes at least some new data therein:
dividing the new data into new data chunks;
calculating the embeddings and the hash values only for the new data chunks;
retaining existing embeddings and hash values for remaining data in the data operation that is not new; and
updating the global signature index with the embeddings and the hash values for the new data chunks.

14. The computer system of claim 13, wherein the operations further comprise:
in response to receiving two or more data operations at the storage system in a predetermined amount of time, combining the data operations;
determining that the combined data operations include new data therein; and
in response to determining the combined data operations include the new data therein:
dividing the new data in the combined data operations into a combined set of new data chunks, and
calculating the embeddings and the hash values only for the new data chunks in the combined set.

15. The computer system of claim 14, wherein the operations further comprise:
in response to determining the combined data operations do not include new data therein:
intentionally refraining from calculating any of the embeddings and/or the hash values for data in the combined data operations; and
correlating the existing embeddings and hash values in the global signature index with the data in the combined data operations.

16. The computer system of claim 13, wherein the determining that the data operation includes new data therein includes:
identifying redundant data in the data operation;
deduplicating the redundant data;
dividing the deduplicated data into new data chunks; and
calculating the embeddings and the hash values once for each deduplicated new data chunk.

17. The computer system of claim 13, wherein the retaining the existing embeddings for remaining data in the data operation that is not new includes intentionally refraining from calculating any of the embeddings for the remaining data.

18. The computer system of claim 13, wherein the operations further comprise:
in response to determining the data operation includes no new data therein:
intentionally refraining from calculating any of the embeddings and/or the hash values for data in the data operation; and
correlating the existing embeddings and hash values in the global signature index with the data in the data operation.

19. A method comprising:
in response to receiving two or more data operations at a storage system in a predetermined amount of time, combining the data operations;
determining that the combined data operations include new data therein by querying a global signature index; and
in response to determining the combined data operations include new data therein:
dividing the new data in the combined data operations into a combined set of new data chunks;
calculating embeddings and hash values only for the new data chunks in the combined set;
retaining existing embeddings and hash values for remaining data in the combined data operations that is not new; and
updating the global signature index with the embeddings and the hash values for the new data chunks.

20. The method of claim 19, further comprising:
in response to determining the combined data operations do not include new data therein:
intentionally refraining from calculating any of the embeddings and/or the hash values for data in the combined data operations; and
correlating the existing embeddings and hash values in the global signature index with the data in the combined data operations.

21. The method of claim 19, wherein the determining whetherthat the combined data operations include new data therein includes:
identifying redundant data in the combined data operations;
deduplicating the redundant data;
dividing the deduplicated data into new data chunks; and
calculating the embeddings and the hash values once for each deduplicated new data chunk.

22. The method of claim 19, wherein the retaining the existing embeddings for remaining data in the combined data operations that is not new includes intentionally refraining from calculating any of the embeddings for the remaining data.

23. The method of claim 19, further comprising:
in response to determining the combined data operations include no new data therein:
intentionally refraining from calculating any of the embeddings and/or the hash values for data in the combined data operations; and
correlating the existing embeddings and the hash values in the global signature index with the data in the combined data operations.

24. A computer program product comprising:
one or more computer-readable storage media; and
program instructions stored on the one or more storage media to perform operations comprising:
in response to receiving two or more data operations at a storage system in a predetermined amount of time, combining the data operations;
determining that the combined data operations include new data therein by querying a global signature index; and
in response to determining the combined data operations include new data therein:
dividing the new data in the combined data operations into a combined set of new data chunks;
calculating embeddings and hash values only for the new data chunks in the combined set;
retaining existing embeddings and hash values for remaining data in the combined data operations that is not new; and
updating the global signature index with the embeddings and the hash values for the new data chunks.

25. The computer program product of claim 24, wherein the operations further comprise:
in response to determining the combined data operations do not include the new data therein:
intentionally refraining from calculating any of the embeddings and/or the hash values for data in the combined data operations; and
correlating the existing embeddings and hash values in the global signature index with the data in the combined data operations.
